(19) United States
(12) Patent Application Publication
(10) Pub. No.: US 2019/0337634 A1
(43) Pub. Date: Nov. 7, 2019

(54) Controlling an Aircraft Based on Detecting Control Element Damage

(71) Applicant: Sikorsky Aircraft Corporation, Stratford, CT (US)

(72) Inventors: Derek H. Geiger, Wilton, CT (US); Matthew A. White, Milford, CT (US); Mark W. Davis, Southbury, CT (US)

(21) Appl. No.: 15/967,949

(22) Filed: May 1, 2018

(51) Int. Cl. B64D 45/00; B64C 13/16

(52) U.S. Cl. CPC B64D 45/00; B64D 2045/0085; B64C 13/16

(57) ABSTRACT

A computer-implemented method and system for controlling an aircraft based on detecting control element damage is disclosed. According to one example, a computer-implemented method includes detecting, by a processing system, damage to a control element of the aircraft. The method further includes characterizing, by the processing system, the damage to determine a corrective action to take based at least in part on the detected damage. The method further includes controlling, by the processing system, the aircraft based at least in part on the corrective action.

### BACKGROUND OF THE INVENTION

Aspects of the present invention are directed to a system for controlling an aircraft and, in particular, to a system for controlling an aircraft based on detecting control element damage.

Aircraft and dynamic components thereof are subject to structural faults, including cracks, corrosion, elastomeric degradation, delamination, penetration due to foreign object impact, erosion, creep, buckling, etc. The aircraft and its components can also fatigue over time from continued use. Fatigue conditions can be determined (e.g., determining that a component is fatiguing rapidly or nearing the end of its useful fatigue life) and damage conditions can also be determined (e.g., determining that a component, such as a control surface, control actuator, or control effector, of the aircraft has suffered damage). These conditions can be alleviated or mitigated to allow safe continued flight, which enhances vehicle safety, reliability, and availability and reduces maintenance costs.

### SUMMARY OF THE INVENTION

According to an aspect of the present invention, a computer-implemented method for controlling an aircraft includes: detecting, by a processing system, damage to a control element of the aircraft; characterizing, by the processing system, the damage to determine a corrective action to take based at least in part on the detected damage; and controlling, by the processing system, the aircraft based at least in part on the corrective action.

According to an aspect of the present invention, the corrective action includes reallocation control from the control element detected as being damaged to another control element of the aircraft.

According to an aspect of the present invention, the corrective action includes limiting an operational envelope of the aircraft.

According to an aspect of the present invention, the corrective action includes limiting an input.

According to an aspect of the present invention, wherein the corrective action comprises alerting an operator of the aircraft that at least one of a control surface, a control effector, and a control actuator is detected as being damaged.

According to an aspect of the present invention, the corrective action includes displaying an operational limit on a display.

According to an aspect of the present invention, the operational limit is selected from the group including an altitude limit, an airspeed limit, a roll-rate limit, a pitch-rate limit, and a yaw-rate limit.

According to an aspect of the present invention, the corrective action includes changing a flight control mode of the aircraft from a lower augmented flight control mode to a higher augmented flight control mode.

According to an aspect of the present invention, detecting the damage includes performing an impact detection and a severity characterization.

According to an aspect of the present invention, detecting the damage includes performing crack detection and a severity characterization.

According to an aspect of the present invention, detecting the damage includes performing a corrosion detection and a severity characterization.

According to an aspect of the present invention, detecting the damage is performed by assessing control element effectiveness.

According to an aspect of the present invention, detecting the control element damage is performed using at least one sensor for detecting or characterizing control element faults, wherein the at least one sensor is selected from the group consisting of an accelerometer, a piezoelectric sensor, fiber optic sensor, a corrosion sensor, and an environmental sensor.

According to an aspect of the present invention, a system for controlling an aircraft includes: a memory including computer readable instructions; and a processing device for executing the computer readable instructions for performing a method, the method including: detecting, by a processing system, damage to a control element of the aircraft; characterizing, by the processing system, the damage to determine a corrective action to take based at least in part on the detected damage; and controlling, by the processing system, the aircraft based at least in part on the corrective action.

According to an aspect of the present invention, the corrective action includes reallocation of control from the control element detected as being damaged to another control element of the aircraft.

According to an aspect of the present invention, the corrective action includes limiting an operational envelope of the aircraft and displaying an alert on a display.

According to an aspect of the present invention, detecting the damage is performed using at least one of a piezoelectric sensor and a fiber optic sensor.

According to an aspect of the present invention, detecting the damage includes performing at least one of an impact detection, a corrosion detection, and a crack detection.

These and other advantages and features will become more apparent from the following description taken in conjunction with the drawings.

### BRIEF DESCRIPTION OF THE DRAWINGS

The subject matter which is regarded as the invention is particularly pointed out and distinctly claimed in the claims at the conclusion of the specification. The foregoing and other features, and advantages of the invention are apparent from the following detailed description taken in conjunction with the accompanying drawings in which:

FIG. 1 illustrates a perspective view of an example of a rotary wing aircraft according to aspects of the present disclosure;

FIG. 2 illustrates a block diagram of a vehicle management system of an aircraft according to aspects of the present disclosure;

FIG. 3 depicts a block diagram of the health management system of FIG. 2 for detecting and characterizing damage according to aspects of the present disclosure; and

FIG. 4 depicts a method for controlling an aircraft based on detecting control element damage according to aspects of the present disclosure.

### DETAILED DESCRIPTION

Aircraft use various control elements such as surfaces, effectors, and actuators, to perform flight maneuvers. For example, high-speed rotorcraft can utilize control surfaces stabilizers and rudders (or a tail in general) for stability and control at high speed. Control actuators can be used to manipulate the control surfaces to cause the control surfaces to change orientation, position, angle, etc. Control effectors are force and/or moment generators. Damage or loss of these control elements can adversely impact stability and control of the aircraft. Moreover, an operator (e.g., a pilot) may be unaware that an element has been damaged, even during maneuvering flight, until stability margins have eroded. For example, if the aircraft is in a hover state, the pilot might be unaware of damage (e.g., a bird strike, a bullet impact, etc.) caused to a rudder.

To address these problems, one or more embodiments of the present invention detect damage to a control element of an aircraft and then control the aircraft based on the detected damage. More particularly, an embodiment of the techniques described herein includes detecting damage to a control element of an aircraft, characterizing the damage to determine a corrective action to take based at least in part on the detected damage, and controlling the aircraft based at least in part on the corrective action. The corrective action can include reallocating controls from a damaged control element to another control element, limiting an operational envelope (e.g., based on a type and/or severity of the damage), limiting an operational input, alerting an operator/pilot of the damage, displaying a characteristic limit such as altitude, landing slopes, payload limitations (including, but not limited to external slung loads), load factor, sideslip, angle of attack, takeoff/taxi/landing speeds, super-pointing capability, propeller clutch state, propeller feathering limits, engine limits, and the like and/or combinations thereof.

An automatic change from a lower augmented flight control mode to a higher augmented flight control mode (e.g. rate command/attitude hold to attitude command/velocity hold) may also occur as damage is detected. This change in flight control mode is based at least in part on the detected damage, and the operational envelope limiting required. By detecting damaged control elements and determining and implementing a corrective action based on the damaged control element, the aircraft can be operated/controlled in a safe and reliable manner, despite the damaged control element. The rate of further damage accumulation or progression can be reduced or minimized. Moreover, because the mitigation allows the aircraft to be operated safely (e.g., within a reduced operational envelope), this prevents the aircraft from experiencing a catastrophic failure due to the damaged control element.

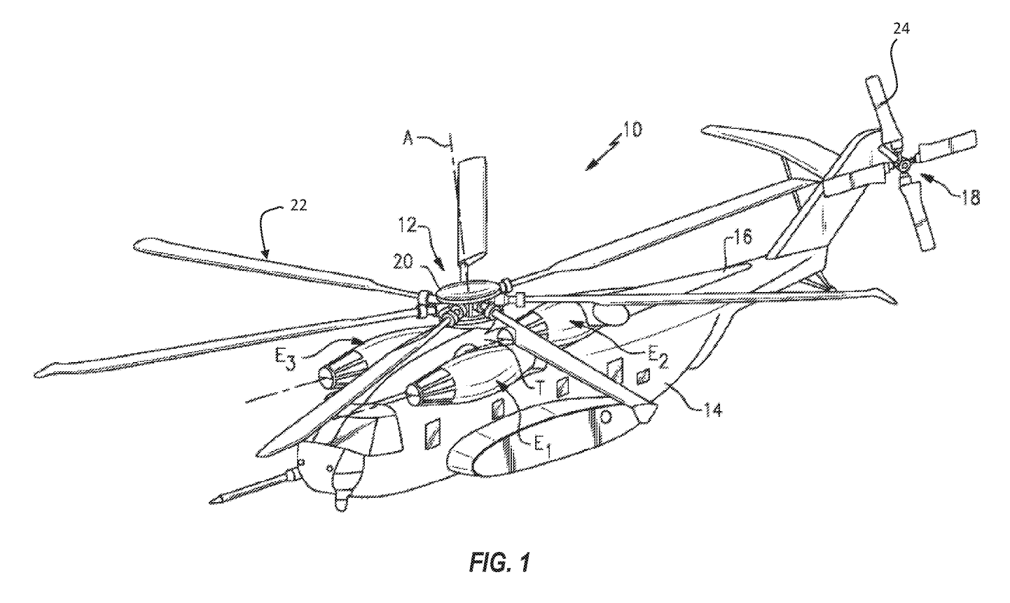

Referring now to the figures, FIG. 1 schematically illustrates an example of a rotary wing aircraft 10 having a main rotor assembly 12. The aircraft 10 includes an airframe 14 having an extending tail 16 which mounts a tail rotor system 18, such as an anti-torque system, a translational thrust system, a pusher propeller, a rotor propulsion system, and the like. The main rotor assembly 12 includes a plurality of rotor blade assemblies 22 mounted to a rotor hub 20. The main rotor assembly 12 is driven about an axis of rotation A through a main gearbox (illustrated schematically at T) by one or more engines E. Although a particular helicopter configuration is illustrated and described in the disclosed embodiment, other configurations and/or machines, such as high speed compound rotary wing aircraft with supplemental translational thrust systems, dual contra-rotating, coaxial rotor system aircraft, tilt-rotors and tilt-wing aircraft, and fixed-wing aircraft, will also benefit from embodiments of the invention.

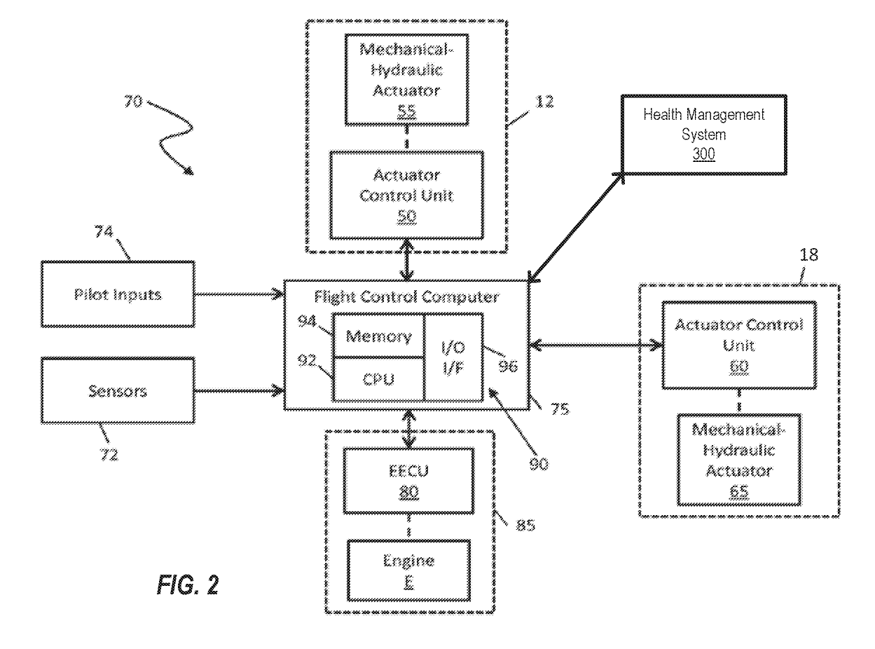

Portions of the aircraft 10, such as the main rotor system 12 and the tail rotor system 18 for example, are driven by a vehicle management system (VMS) 70 illustrated in FIG. 2. The VMS 70 includes a flight control system, sticks, pedals, displays, visual/audio/tactical cues, and a health management system 300. In one embodiment, the vehicle management system 70 is a fly-by-wire (FBW) control system. In a FBW control system, there is no direct mechanical coupling between a pilot's controls and movable components or control surfaces, such as rotor blade assemblies 22 or tail rotor blades 24 for example, of the aircraft 10 of FIG. 1. In other embodiments, the vehicle management system 70 can control any suitable vehicle or aircraft and need not be a FBW control system. Instead of using mechanical linkages, a FBW control system includes a plurality of sensors 72 which can sense the position of controlled elements and generate electrical signals proportional to the sensed position. The sensors 72 can also be used directly and indirectly to provide a variety of aircraft state and health data to a flight control computer (FCC) 75 and/or a vehicle management system (VMS) 70. The VMS 70 includes control inputs, sensors, health management (e.g., detection, characterization), corrective action determination, flight controls, and actuation.

Additionally one or more of the sensors 72 can be used for to detect structural fault/damage to control surfaces, effectors, or actuators. In such cases, one or more of the sensors 72 can include an accelerometer, a piezoelectric sensor, fiber optic sensor, a corrosion sensor, and an environmental sensor, among others. The sensors 72 can also include pressure sensors, force sensors, vibration sensors, accelerometers, piezoelectric sensors, fiber optic sensors, and other sensors. The FCC 75 can also receive inputs 74 as control commands to control the lift, propulsive thrust, yaw, pitch, and roll forces and moments of the various control elements of the aircraft 10.

Although a particular aircraft configuration is illustrated and described in the disclosed embodiment, other configurations of aircraft and vehicles, such as single and/or multi-engine fixed wing aircraft, vertical take-off and landing (VTOL) rotary wing aircraft, high speed compound rotary wing aircraft with supplemental translational thrust systems, dual contra-rotating, coaxial rotor system aircraft, tilt-rotors and tilt-wing aircraft, and fixed-wing aircraft can also benefit from embodiments of the disclosure.

In response to inputs from the sensors 72 and inputs 74, the FCC 75 transmits signals to various subsystems of the aircraft 10, such as the main rotor system 12 and the tail rotor system 18. The FCC 75 can use reference values in the inputs 74 for feedforward control to quickly respond to changes in the reference values and can perform feedback control to reject disturbances detected via the sensors 72. Inputs 74 can be in the form of stick commands and/or beeper commands to set and incrementally adjust reference values for controllers. The inputs 74 need not be directly provided by a human pilot, but may be driven by an automatic pilot, a remote control, a navigation-based control, or one or more outer control loops configured to produce one or more values used to pilot the aircraft 10.

The main rotor system 12 can include an actuator control unit 50 configured to receive commands from the FCC 75 to control one or more actuators 55, such as a mechanical-hydraulic actuator, for the rotor blade assemblies 22 of FIGS. 1 and 2. In an embodiment, inputs 74 including cyclic and/or collective commands can result in the actuator control unit 50 driving the one or more actuators 55 to adjust a swashplate assembly to control the rotor blade assemblies 20 of FIG. 1. Alternatively, the FCC 75 can directly control the one or more actuators 55, and the actuator control unit 50 can be omitted.

The tail rotor system 18 can include an actuator control unit 60 configured to receive commands from the FCC 75 to control one or more actuators 65, such as a mechanical-hydraulic actuator, associated with one or more tail rotor or propeller blades 24. In an embodiment, inputs 74 include a blade pitch command for the actuator control unit 60 to drive the one or more actuators 65 for controlling the tail rotor blades FIG. 1. Alternatively, the FCC 75 can directly control the one or more actuators 65, and the actuator control unit 60 can be omitted.

The FCC 75 can also interface with an engine control system 85 including one or more electronic engine control units (EECUs) 80 to control the engines E. Each EECU 80 can be a digital electronic control unit such as Full Authority Digital Engine Control (FADEC) electronically interconnected to a corresponding engine E. Each engine E can include one or more instances of the EECU 80 to control engine output and performance. Engines E can be commanded in response to the inputs 74, such as a throttle command.

Rather than simply passing inputs 74 through to various control units 50, 60, and 80, the FCC 75 includes a processing system 90 that applies models and control laws to augment commands. The processing system 90 includes processing circuitry 92, memory 94, and an input/output (I/O) interface 96. The processing circuitry 92 can be any type or combination of computer processors, such as a microprocessor, microcontroller, digital signal processor, application-specific integrated circuit, programmable logic device, and/or field programmable gate array, and is generally referred to as central processing unit (CPU) 92. The memory 94 can include volatile and non-volatile memory, such as random-access memory (RAM), read-only memory (ROM), or other electronic, optical, magnetic, or any other computer-readable storage medium onto which data and control logic as described herein are stored. Therefore, the memory 94 is a tangible storage medium where instructions executable by the processing circuitry 92 are embodied in a non-transitory form. The I/O interface 96 can include a variety of input interfaces, output interfaces, communication interfaces and support circuitry to acquire data from the sensors 72, inputs 74, and other sources (not depicted) and can communicate with the control units 50, 60, 80, and other subsystems (not depicted).

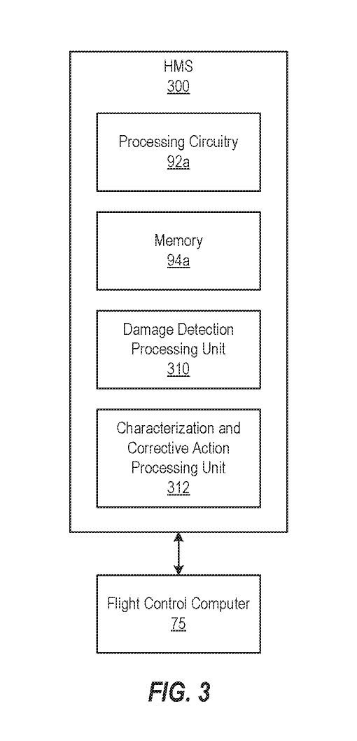

FIG. 3 depicts a block diagram of the health management system (HMS) 300 of FIG. 2 for detecting and characterizing damage according to aspects of the present disclosure. The HMS 300 includes processing circuitry 92a (e.g., a processor, processing device, processing unit, etc.) and memory 94a. The HMS 300 further includes a damage detection processing unit 310 and a corrective action processing unit 312. The HMS 300 is in electronic communication with the flight control computer 75 of FIG. 2.

Control elements (e.g., surfaces, actuators, effectors, etc.) enable an aircraft to be controlled. For example, changes to a control surface affect the aircraft's operational capabilities. Control surfaces can include stabilizers, rudders, rotors, ailerons, flaps, elevators, etc. If one or more of an aircraft's control elements become damaged, the aircraft's stability and ability to maneuver.

The damage detection processing unit 310 detects damage to a control element of an aircraft. The damage to the control element can include damage to a control surface of an aircraft (e.g., the aircraft 10), damage to a control effector of the aircraft, and/or damage to a control actuator of the aircraft. To detect control element damage, the damage detection processing unit 310 can receive signals from sensors associated with various control elements of the aircraft. For example, an aircraft can include pressure sensors, force sensors, vibration sensors, accelerometers, piezoelectric sensors, fiber optic sensors, and other sensors. These sensors monitor various aspects of the aircraft and its control elements. By monitoring signals from one or more of these sensors, the damage detection pressure sensors, force sensors, vibration sensors, accelerometers, piezoelectric sensors, fiber optic sensors, and other sensors can determine whether a control element becomes damaged. In some examples, the damage detection pressure sensors, force sensors, vibration sensors, accelerometers, piezoelectric sensors, fiber optic sensors, and other sensors uses impact detection, corrosion detection, and/or crack detection. In some examples, performing the impact detection, corrosion detection, and/or crack detection also includes categorizing the impact, corrosion, or crack. For example, the impact, corrosion, or crack can be categorized as being either above or below a threshold or concern limit. The effectiveness of the control element can also be assessed to determine, for example, how effective the control element is at fulfilling its intended purpose.

If it is detected that a control element is damaged, the corrective action processing unit 312 characterizes the damage to determine a corrective action to take based on the severity of the detected damage. For example, the corrective action processing unit 312 characterizes the type and severity of damage that is detected to the control element and determines a corrective action to take based thereon. The characterization can include comparing the damage to a threshold or other limit to characterize the damage (e.g., if the damage is above a threshold, the damage may be classified as severe, while if the damage is below the threshold, the damage may be classified as minor, etc.). The corrective action can enable the aircraft to continue to operate while preventing the aircraft from operating beyond conditions or limits that may cause harm or danger to the aircraft based on the damaged control element. In some examples, the corrective action is implemented automatically (with or without alerting a pilot or operator); however, in other examples, the corrective action is implemented manually by a pilot or operator.

As an example, the corrective action processing unit 312 can reallocate control from the damaged control element to another control element. For example, if a left elevator is determined to be damaged, the corrective action processing unit 312 can reallocate control from the left elevator to the right elevator.

As another example, the corrective action processing unit 312 can limit an operational envelope of the aircraft. Limiting the operational envelope can include limiting speed, altitude, tail load limit, the rate of roll/pitch/yaw, etc. In an example in which the aircraft is an autonomous aircraft, the corrective action may be to implement a safe mode that causes the aircraft to fly within a limited operational envelope and begin a landing sequence to safely land the aircraft.

As yet another example, the corrective action processing unit 312 can limit a flight input. For example, the range of motion of a throttle, a cyclic stick, a collective lever, pedals, a joystick, etc. can be limited.

In some examples, a pilot or operator of the aircraft can be alerted to the detected damage and/or the limits to the flight input and/or operating envelope. For example, an alert or message can be displayed on a display of the aircraft or otherwise visible to the pilot or operator to provide information to the pilot or operator. The corrective action processing unit 312 can display a flight characteristic limit (e.g., an altitude limit, an airspeed limit, a roll-rate limit, a pitch-rate limit, a yaw-rate limit, etc.) on the display.

Once the corrective action processing unit 312 characterizes the damage and determines the corrective action to take, the flight control computer 75 implements the action to control the aircraft. For example, if the corrective action is a reallocation of control from a damaged control surface to another (non-damaged) control surface, future command inputs are allocated to the non-damaged control surface instead of the damaged control surface. In another example, if the corrective action is to limit an operational envelope of the aircraft, the aircraft is controlled within the limited operational envelope.

The various components, modules, engines, etc. described regarding FIG. 3 can be implemented as instructions stored on a computer-readable storage medium, as hardware modules, as special-purpose hardware (e.g., application specific hardware, application specific integrated circuits (ASICs), as embedded controllers, hardwired circuitry, etc.), or as some combination or combinations of these. In examples, the engine(s) described herein can be a combination of hardware and programming. The programming can be processor executable instructions stored on a tangible memory (e.g., the memory 94a), and the hardware can include processing circuitry 92a for executing those instructions. Thus the memory 94a can store program instructions that when executed by processing circuitry 92a implement the engines described herein. Other engines can also be utilized to include other features and functionality described in other examples herein. Alternatively or additionally, the HMS 300 can include dedicated hardware, such as one or more integrated circuits, Application Specific Integrated Circuits (ASICs), Application Specific Special Processors (ASSPs), Field Programmable Gate Arrays (FPGAs), etc. or any combination of the foregoing examples of dedicated hardware, for performing the techniques described herein. In some examples, such as when the aircraft 10 is a vertical lift aircraft, distributed processing units can be implemented that perform some of the functions described in this block diagram and they may not be in one device.

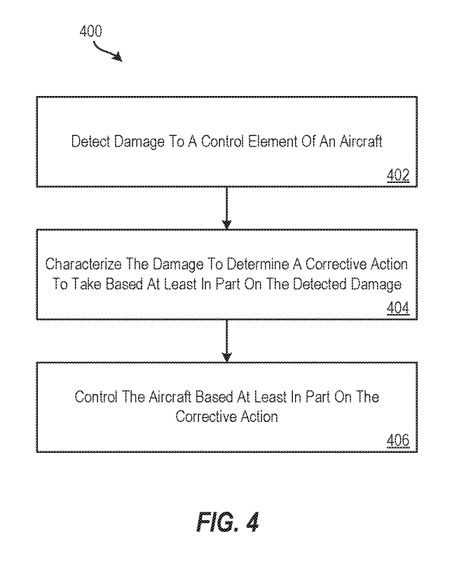

FIG. 4 depicts a method 400 for controlling an aircraft based on detecting fatiguing conditions and aircraft damage according to aspects of the present disclosure. The method 400 can be implemented, for example, by the FCC 75 of FIG. 2, the HMS 300 of FIG. 3, or by another suitable processing system.

The method 400 begins at block 402, where the damage detection processing unit 310 detects damage to a control element of an aircraft (e.g., the aircraft 10). The control element can include a control surface, a control effector, and/or a control actuator. In examples, detecting the damage includes performing an impact detection, corrosion detection, and/or a crack detection. The damage detection can be performed using sensors associated with the various control elements of the aircraft.

At block 404, the corrective action processing unit 312 characterizes the damage to determine a corrective action to take based at least in part on the severity of the detected damage. The corrective action can include reallocating controls from a damaged control element to another control element, limiting an operational envelope (e.g., based on a type and/or severity of the damage), limiting a flight input, alerting an operator/pilot of the damage, displaying a flight characteristic limit (e.g., an altitude limit, an airspeed limit, a roll-rate limit, a pitch-rate limit, a yaw-rate limit, etc.), and the like and/or combinations thereof.

At block 406, the flight control computer 75 controls the aircraft based at least in part on the corrective action. For example, the flight control computer 75 can reallocate controls to a non-damaged control element. By controlling the aircraft based on the corrective action, the aircraft can continue to operate despite the damaged control element.

Additional processes also can be included, and it should be understood that the processes depicted in FIG. 4 represent illustrations and that other processes can be added or existing processes can be removed, modified, or rearranged without departing from the scope and spirit of the present disclosure.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention can include only some of the described embodiments. Accordingly, the invention is not to be seen as limited by the foregoing description.

What is claimed is:

1. A computer-implemented method for controlling an aircraft, comprising:
detecting, by a processing system, damage to a control element of the aircraft;
characterizing, by the processing system, the damage to determine a corrective action to take based at least in part on the detected damage; and
controlling, by the processing system, the aircraft based at least in part on the corrective action.

2. The computer-implemented method of claim 1, wherein the corrective action comprises reallocation control from the control element detected as being damaged to another control element of the aircraft.

3. The computer-implemented method of claim 1, wherein the corrective action comprises limiting an operational envelope of the aircraft.

4. The computer-implemented method of claim 1, wherein the corrective action comprises limiting an input.

5. The computer-implemented method of claim 1, wherein the corrective action comprises alerting an operator of the aircraft that at least one of a control surface, a control effector, and a control actuator is detected as being damaged.

6. The computer-implemented method of claim 1, wherein the corrective action comprises displaying an operational limit on a display.

7. The computer-implemented method of claim 6, wherein the operational limit is selected from the group comprising an altitude limit, an airspeed limit, a roll-rate limit, an angle of bank limit, a pitch attitude limit, a pitch-rate limit, and a yaw-rate limit.

8. The computer-implemented method of claim 1, wherein detecting the damage comprises performing an impact detection and a severity characterization.

9. The computer-implemented method of claim 1, wherein detecting the damage comprises performing a crack detection and a severity characterization.

10. The computer-implemented method of claim 1, wherein detecting the damage comprises performing a corrosion detection and a severity characterization.

11. The computer-implemented method of claim 1, wherein detecting the damage is performed using at least one sensor for detecting or characterizing control element faults, wherein the at least one sensor is selected from the group consisting of an accelerometer, a piezoelectric sensor, a fiber optic sensor, a corrosion sensor, and an environmental sensor.

12. The computer-implemented method of claim 1, wherein the corrective action comprises changing a flight control mode of the aircraft from a lower augmented flight control mode to a higher augmented flight control mode.

13. The computer-implemented method of claim 1, wherein detecting the damage is performed by assessing control element effectiveness.

14. A system for controlling an aircraft, the system comprising:
a memory comprising computer readable instructions; and
a processing device for executing the computer readable instructions for performing a method, the method comprising:
detecting, by a processing system, damage to a control element of the aircraft;
characterizing, by the processing system, the damage to determine a corrective action to take based at least in part on the detected damage; and
controlling, by the processing system, the aircraft based at least in part on the corrective action.

15. The system of claim 14, wherein the corrective action comprises reallocation control from the control element detected as being damaged to another control element of the aircraft.

16. The system of claim 14, wherein the corrective action comprises limiting an operational envelope of the aircraft and displaying an alert on a display.

17. The system of claim 14, wherein detecting the damage is performed using at least one sensor for detecting or characterizing control element faults, wherein the at least one sensor is selected from the group consisting of an accelerometer, a piezoelectric sensor, a fiber optic sensor, a corrosion sensor, and an environmental sensor.

18. The system of claim 14, wherein detecting the damage comprises performing at least one of an impact detection, a corrosion detection, and a crack detection.
